(19) United States
(12) Patent Application Publication
(10) Pub. No.: US 2025/0307760 A1
(43) Pub. Date: Oct. 2, 2025

(54) AUTOMATING OPTIONS CLAUSE MANAGEMENT USING INFERENCE MODELS

(71) Applicant: Dell Products L.P., Round Rock, TX (US)

(72) Inventors: LEV MAKLER, Be'er Sheva (IL); OFIR EZRIELEV, Be'er Sheva (IL); ANAT PARUSH TZUR, Tel Aviv (IL); AMIHAI SAVIR, Newton, MA (US)

(21) Appl. No.: 18/622,021

(22) Filed: Mar. 29, 2024

(51) Int. Cl. G06Q 10/087; G06Q 30/0202

(52) U.S. Cl. CPC G06Q 10/087; G06Q 30/0202

(57) ABSTRACT

Methods and systems for managing contracts are disclosed. To manage contracts with a supplier of products, a recommendation may be obtained indicating that an options clause is to be added to a contract. An options offer may then be obtained using the recommendation indicating a first quantity of the products to be provided by the supplier and a first price to be paid for the products. A counteroffer may then be obtained from the supplier indicating a second quantity of the products to be provided by the supplier and a second price to be paid for the products. A determination may then be made using the counteroffer and acceptability criteria regarding whether the counteroffer is acceptable. If the counteroffer is acceptable, the contract may be updated to include the options clause indicating the second quantity of products and the second price to be paid for the products.

### FIELD

Embodiments disclosed herein relate generally to contract management. More particularly, embodiments disclosed herein relate to systems and methods to manage contracts with suppliers of products.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2D show diagrams illustrating data flows in accordance with an embodiment.

FIG. 3 shows a flow diagram illustrating methods of managing contracts in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing contracts with suppliers of a product. To manage the contracts, a recommendation may be obtained indicating that an options clause is to be added to a contract with a supplier.

The recommendation may be used to generate a set of options offers. The set of options offers may include one or more options offers for each of the suppliers. Each options offer may indicate a quantity of products to be provided by the supplier to modify a quantity of products indicated by the contract and a price to be paid for the products via the addition of the quantity to an options clause. The quantity of products included in the options offer may be selected to hedge against an uncertainty in a predicted difference between supply of the products and demand for the products over a duration of time.

The set of options offers may be provided to the suppliers, which may collectively provide a set of counteroffers in response to receiving the set of options offers. Each counteroffer of the set of counteroffers may include a quantity of products to be provided by the supplier and a price to be paid for the products.

A determination may then be made regarding whether the set of counteroffers is acceptable. To make the determination, each counteroffer of the set of counteroffers may be combined to obtain a total quantity of products and total price to be paid for the products. The combined set of counteroffers may then be compared to acceptability criteria to determine whether the set of counteroffers is acceptable. The acceptability criteria may include a ratio of a cost for hedging against the uncertainty to a cost for insufficient product supply.

If the set of counteroffers is acceptable based on the acceptability criteria, then the contracts may be updated with options clauses which includes the quantity of products and the price to be paid for the products indicated in the counteroffers. If the set of counteroffers is not acceptable based on the acceptability criteria, then the set of options offers may be iteratively modified until the set of counteroffers based on the set of modified options offers is acceptable.

Thus, embodiments disclosed herein may address, among other technical problems, the technical challenge of generating an options clause of a contract with a supplier of multiple suppliers of a product. By automating options clause generation, a quantitative assessment may be made regarding the quantity of products and the price to be paid for the products to be included in the options clause of the contract with each supplier. Both the total quantity of products and the total cost of the products may be globally optimized with respect to the cost of hedging against the risk of insufficient product supply and the cost of insufficient product supply, which may allow for the generation of options clauses that are more likely to meet the supply needs and risk tolerance of a company.

In an embodiment, a method for managing contracts is disclosed. The method may include: obtaining a recommendation, the recommendation indicating that an options clause is to be added to a contract of the contracts; obtaining, using the recommendation, an options offer of a set of options offers, the options offer indicating a first quantity of the products to be provided by a supplier of the suppliers when the options clause is exercised and a first price to be paid for the products; obtaining a counteroffer of a set of counteroffers, the counteroffer being obtained from the supplier and indicating a second quantity of the products to be provided by the supplier when the options clause is exercised and a second price to be paid for the products; making a determination, using the counteroffer and acceptability criteria, regarding whether the counteroffer is acceptable; and in a first instance of the determination in which the counteroffer is acceptable based on the acceptability criteria: updating the contract to include the options clause, the options clause indicating the second quantity of products to be provided by the suppliers when the options clause is exercised and the second price to be paid for the products.

The method may also include in a second instance of the determination in which the counteroffer is not acceptable based on the acceptability criteria: obtaining an updated options offer; obtaining an updated counteroffer from the supplier; making a second determination, using the acceptability criteria regarding whether the updated counteroffer is acceptable; in a first instance of the second determination in which the updated counteroffer is not acceptable: continuing to iteratively modify the updated options offer until a counteroffer based on the modified updated options offer is acceptable.

Obtaining the recommendation may include: obtaining, using a set of demand predictions generated by a first inference model, an aggregated demand prediction, the aggregated demand prediction being intended to predict demand for the products over a duration of time; comparing the aggregated demand prediction to an aggregated supply prediction, the aggregated supply prediction being based on a set of supply predictions generated by a second inference model and being intended to predict supply of the products over the duration of time to obtain a difference; making a determination, using the difference and the acceptability criteria, regarding whether the difference is acceptable; and in a first instance of the determination in which the difference is not acceptable: generating the recommendation to add the options clause to the contract with a supplier, the recommendation indicating a quantity of the products to be provided by the supplier when the options clause is exercised.

Obtaining the aggregated demand prediction may include: obtaining demand data; obtaining, using the first inference model and the demand data, the set of demand predictions; and aggregating the set of demand predictions to obtain the aggregated demand prediction.

Comparing the aggregated demand prediction to the aggregated supply prediction may include: obtaining supply data; obtaining, using the second inference model and the supply data, the set of supply predictions; and aggregating the set of supply predictions to obtain the aggregated supply prediction.

The difference may include: a quantity of products needed for product supply to meet product demand over the duration of time; and a level of uncertainty in the quantity of products needed for the product supply to meet the product demand over the duration of time.

The level of uncertainty in the quantity of products needed for the product supply to meet the product demand over the duration of time may be obtained using quantile regression.

The options clause may include a quantity of products. The quantity may include: the quantity of products needed to hedge against the uncertainty to reduce a likelihood of the quantity of products not meeting the product demand.

The set of options offers may include one or more options offers for each supplier of the suppliers.

Obtaining the options offer of the set of options offers may include: obtaining a neural network trained using training data to globally optimize the options offer as part of the set of options offers; and generating the options offer using the neural network so that a total quantity of products covered the set of options offers is a sufficient quantity of the products to meet a need of a company.

Making the determination may include combining each counteroffer in the set of counteroffers to compare the set of counteroffers to the acceptability criteria.

The acceptability criteria may include a ratio of cost for hedging against uncertainty in the aggregated supply prediction and the aggregated demand prediction to a cost for insufficient product supply.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

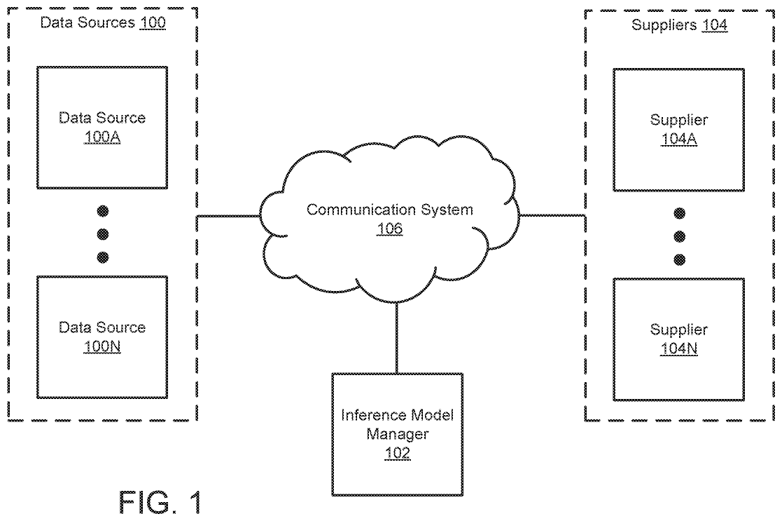

Turning to FIG. 1, a block diagram illustrating a system in accordance with an embodiment is shown. The system shown in FIG. 1 may provide computer-implemented services utilizing data obtained from any number of data sources and stored in a data repository prior to performing the computer-implemented services. The computer-implemented services may include any type and quantity of computer-implemented services. For example, the computer-implemented services may include contract managing services and/or any other type of computer-implemented services.

To provide the computer-implemented services, the system may include data sources 100. Data sources 100 may include any number of data sources. For example, data sources 100 may include one data source (e.g., data source 100A) or multiple data sources (e.g., 100A-100N). Each data source of data sources 100 may include hardware and/or software components configured to obtain data, store data, provide data to other entities, and/or to perform any other task to facilitate performance of the computer-implemented services.

All, or a portion, of data sources 100 may provide (and/or participate in and/or support the) computer-implemented services to various computing devices operably connected to data sources 100. Different data sources may provide similar and/or different computer-implemented services.

For example, data sources 100 may include demand data regarding demand for a product. The demand data may include (i) historical data regarding demand for the product, (ii) historical data regarding consumer spending, (iii) forecasted data regarding market trends (e.g., which may impact demand for the product), (iv) data regarding the consumer, and/or (v) other demand data.

Additionally, data sources 100 may include supply data regarding supply of a product. The supply data may include (i) historical data regarding market availability of the product (e.g., from any number of suppliers), (ii) historical data regarding supply of the product from a supplier, (iii) historical data regarding the likelihood of fulfillment of a contract for a product with the supplier, (iv) forecasted data regarding market trends, (v) data regarding the supplier, and/or (iv) other supply data.

Data sources 100 may provide the data (e.g., the supply data, the demand data) to inference model manager 102. Inference model manager 102 may use the data to make predictions regarding whether a contract between a company and a supplier will include a sufficient quantity of products for the supply of products from the supplier to meet the demand for products by the company. If inference model manager 102 determines there is a risk the contract will not provide a sufficient quantity of products for the supply of products to meet the demand for products, inference model manager 102 may generate a recommendation to update the contract. The recommendation may include a quantity of products needed to add to the contract via an options clause to hedge against the risk that the product demand exceeds product supply.

For example, the company may sell computers. To sell the computers, the company may have a contract with a supplier for a material needed to build the computer (e.g., a hard drive). Inference model manager 102 may make predictions to determine whether the contract the company has with a supplier of hard drives will provide a sufficient quantity of hard drives to meet the need of the company for hard drives. If there is a risk the company will not obtain a sufficient quantity of hard drives from the supplier, inference model manager 102 may generate a recommendation to add an options clause to the contract and determine the quantity of hard drives needed to decrease the probability the company will not obtain a sufficient quantity of hard drives.

The recommendation generated by inference model manager 102 may be used to make and/or modify contracts with suppliers of products. For example, the recommendation may be used by a business decision maker within a company tasked with using the recommendation from inference model manager 102 to negotiate the addition of an options clause to a contract with a supplier of a product (e.g., supplier 104A), as well as negotiate the quantity and price of the products to be included in the options clause.

The business decision maker may be responsible for negotiating options clauses with all of the suppliers of a product (e.g., supplier 104A-104N) to optimize the total quantity of products to be provided to the company by the suppliers and the total price to be paid for the products. For example, the company may have a contract with three suppliers for hard drives. The business decision maker may receive a recommendation to add an options clause to at least one contract to ensure the company has a sufficient quantity of hard drives. The business decision maker may then negotiate the contracts with each of the suppliers until an agreement regarding the quantity of products to be added to the options clause(es) and the price to be paid for the products is reached.

While negotiating the contracts, the business decision maker may consume resources inefficiently resulting in incurred expenses for the company, the resources may include: (i) the business decision maker's time, (ii) the business decision maker's cognitive resources, (iii) computing resources consumed while the business decision maker manually analyzes the recommendation and contracts using a computer, and/or (iv) other resources.

Additionally, because the business decision maker may make qualitative assessments during the negotiations and may manually input information into a computer reflective of the qualitative assessments, the business decision maker may make an error. The error may include: (i) incorrectly accounting for total product supply across suppliers, (ii) incorrectly optimizing across suppliers for the best price per product, (iii) incorrectly hedging against the risk indicated in the recommendation that the product supply does not meet product demand, (iv) incorrectly inputting the information into the computer, and/or (v) other errors. As a result of the error, the company may not sufficiently hedge against the risk that the supply of the product does not meet the demand for the product, and/or may purchase products at a higher price than possible, resulting in a loss of revenue.

In general, embodiments disclosed herein may provide methods, systems, and/or devices for managing contracts. To manage contracts, the system may obtain a recommendation recommending the addition of an options clause to a contract with a supplier of a product and indicating a quantity of products needed to hedge against the uncertainty that product supply does not meet product demand based on the existing contract.

Using the recommendation, a set of options offers may be generated, indicating a quantity of products to be included in the options clause and the price to be paid for the products in each of the contracts with each of the suppliers of the product. The set of options offers may then be provided to the suppliers, and a set of counteroffers may be obtained from the suppliers in response.

The set of counteroffers may then be compared to acceptability criteria to determine if the set of counteroffers is acceptable. If the set of counteroffers is acceptable, the contracts with the suppliers may be updated (via the addition of options clauses) to reflect the quantity of products and price to be paid for each of the products indicated in the counteroffers. If the set of counteroffers is not acceptable, the set of counteroffers may be used as a basis for generating a new set of options offers to be sent to the suppliers. The system may continue to iteratively modify the updated options offers until the set of counteroffers obtained from the suppliers in response is deemed acceptable based on the acceptability criteria.

By doing so, a system in accordance with an embodiment may increase the likelihood of optimizing both the quantity of products to be included to an options clause of a contract and the price to be paid for the products by considering each contract with a supplier in the context of a set of contracts with all of the suppliers of the product. As a result, a system in accordance with an embodiment may quantitatively assess the contract options as a whole in order to balance the cost for hedging against the uncertainty that product supply will not meet product demand with the costs resulting from insufficient product supply. In addition to improving options clause optimization, automating contract negotiation using computer-implemented methods may also reduce resource consumption, further reducing overall costs regarding contract management.

To perform the above-noted functionality, the system of FIG. 1 may include data sources 100, inference model manager 102, and/or suppliers 104. Each of these components is discussed below.

Data sources 100 may include data from any number of sources (e.g., data sources 100A-100N), and may provide data to inference model manager 102. Data provided to inference model manager 102 by data sources 100 may include training data usable to train inference models managed by inference model manager 102 and/or input data usable as ingest for inference models managed by inference model manager 102. Inference model manager 102 may include any number and/or type of data processing systems. The data processing systems may train and/or host any number and/or type of inference models trained to generate inferences (e.g., predictions).

Inference model manager 102 may provide inference model management services. To provide the inference model management services, inference model manager 102 may obtain data (e.g., from data sources 100), process the data (e.g., fill data gaps, transform the data, extract values from the data), use training data to train any number of inference models, generate predictions (e.g. using the data as input for the inference models), analyze the predictions (e.g., make comparisons between predictions) and/or may provide the predictions to other entities (e.g., suppliers 104) as part of facilitating the computer-implemented services.

For example, inference model manager 102 may host a first inference model which uses data obtained from data sources 100 to generate a recommendation indicating whether an options clause should be added to a contract with a supplier of a product and the quantity of products which is needed to hedge against the uncertainty that product supply does not meet product demand.

Inference model manager 102 may also host a second inference model which uses the recommendation obtained from the first inference model to generate a set of options offers. Each options offer in the set of options offers may indicate a quantity of products to be included in an options clause of a contract with a supplier and a price to be paid for the products. Inference model manager 102 may provide the set of options offers to suppliers 104.

Suppliers 104 may include any number and/or type of data processing systems used by any number of suppliers (e.g., supplier 104A-104N) to negotiate contracts with other entities (e.g., inference model manager 102). After obtaining the set of options offers from inference model manager 102, suppliers 104 may generate a set of counteroffers, which may include one counteroffer from each supplier. Each counteroffer of the set of counteroffers may include: (i) a quantity of products and a price to be paid for the products equal to that of the options offer, (ii) a quantity of products and a price to be paid for the products different from that of the options offer, and/or (iii) other counteroffers.

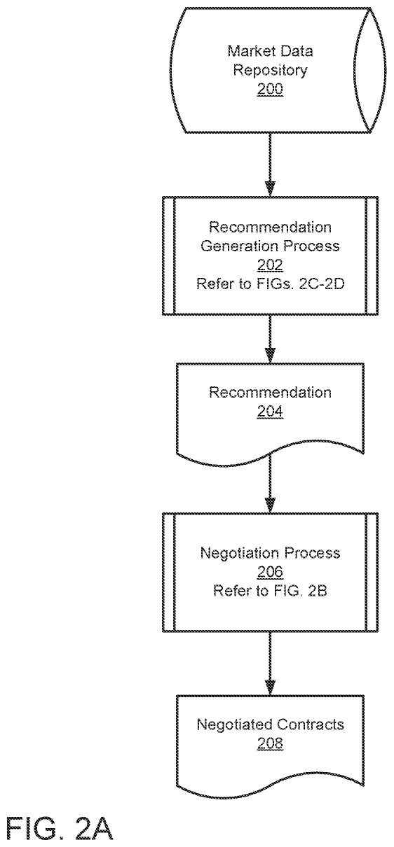

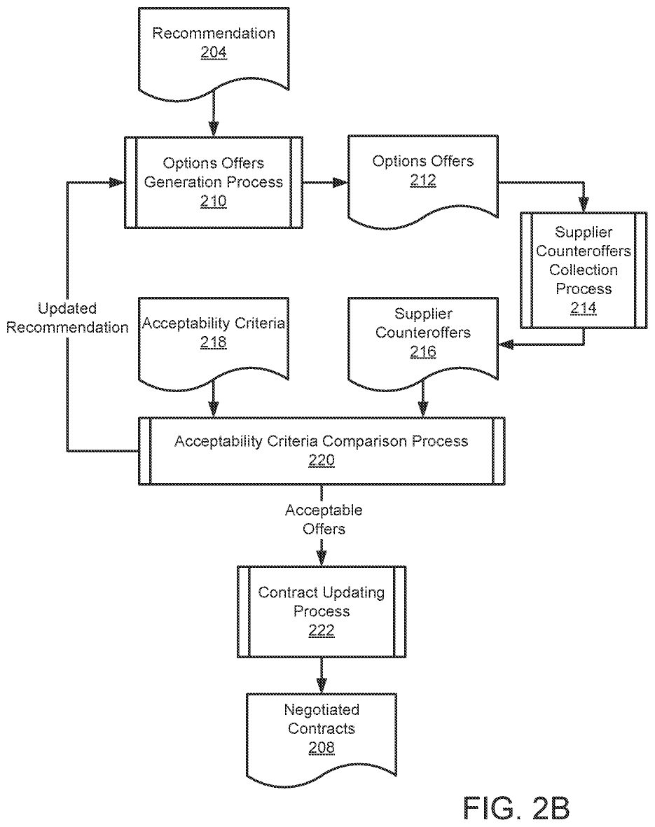

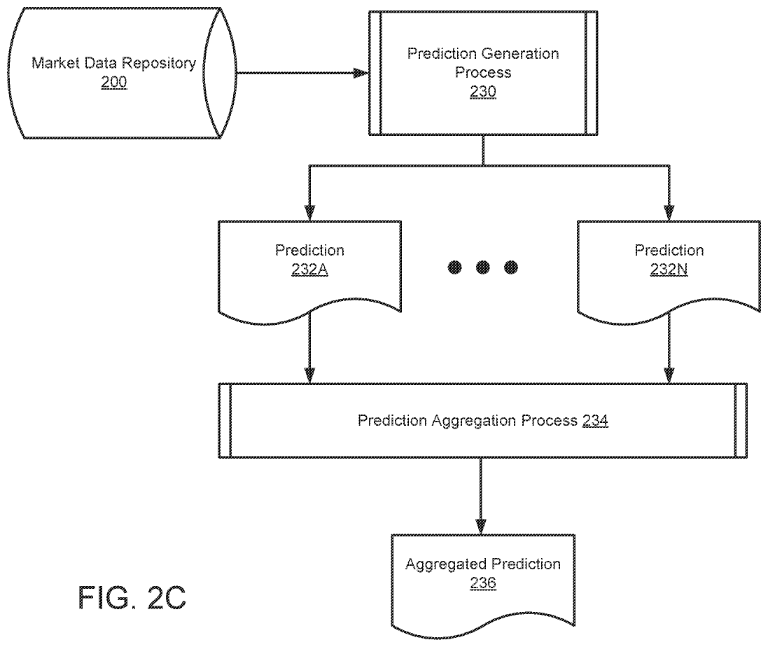

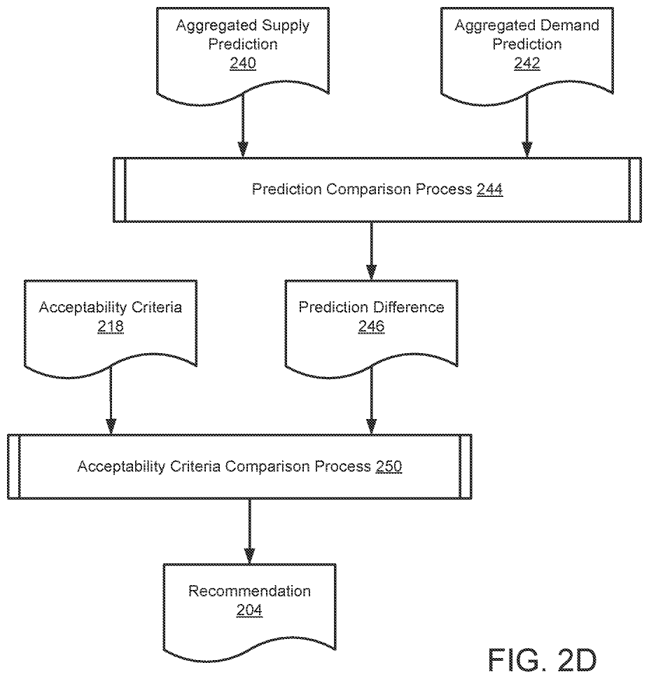

Suppliers 104 may provide the set of counteroffers to inference model manager 102. Inference model manager 102 may use acceptability criteria to determine whether the set of counteroffers is acceptable. Inference model manager 102 may negotiate with suppliers 104 until an acceptable set of counteroffers is obtained. Refer to FIG. 2B for additional details regarding determining counteroffer acceptability.

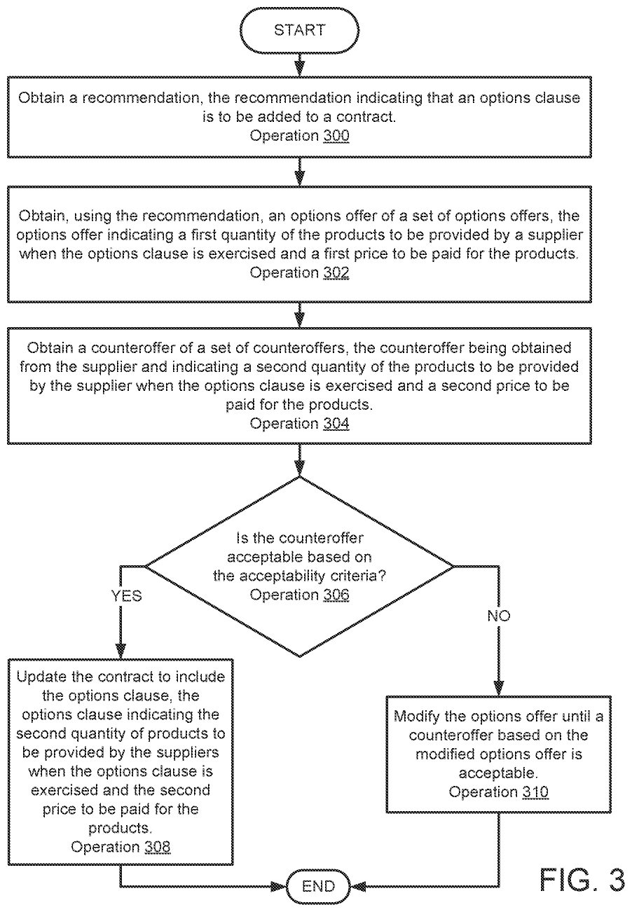

When providing their functionality, any of data sources 100, inference model manager 102, and suppliers 104 may perform all, or a portion, of the processes, interactions, and methods illustrated in FIGS. 2A-3.

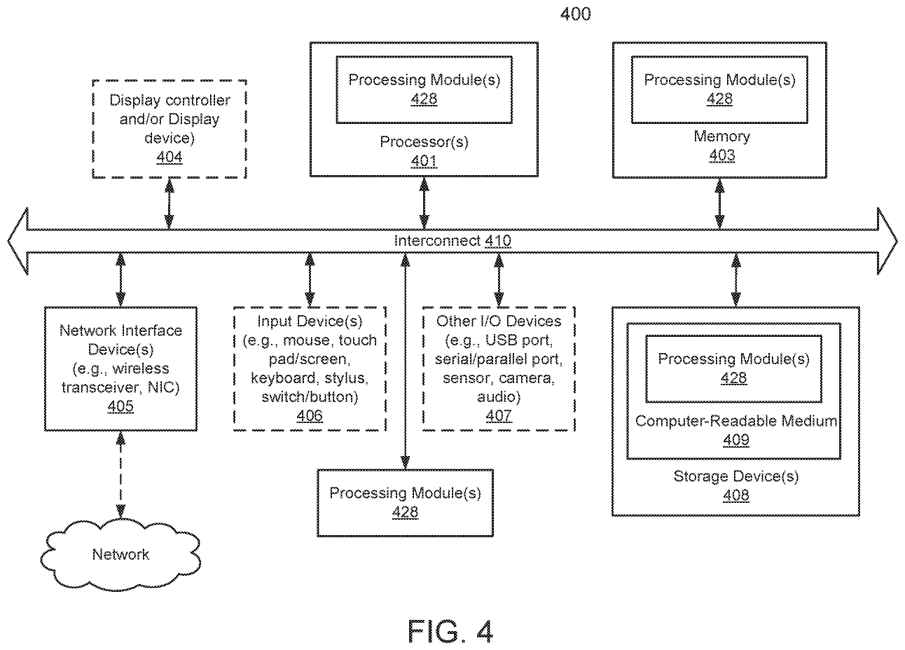

Any of data sources 100, inference model manager 102, and suppliers 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 204, 208, etc.) is used to represent data structures, a second set of shapes (e.g., 202, 206, etc.) is used to represent processes performed using and/or that generate data, and a third set of shapes (e.g., 200, etc.) is used to represent large scale data structures such as databases.

Turning to FIG. 2A, a first data flow diagram in accordance with an embodiment is shown. The first data flow diagram may illustrate data used in and data processing performed in generating negotiated contracts 208.

To generate negotiated contracts 208, recommendation generation process 202 may be performed using data from market data repository 200. Market data repository 200 may include data from any number of data sources, and may include data regarding: (i) product supply, (ii) product demand, and/or (iii) other data.

During recommendation generation process 202, demand data from market data repository 200 may be used by a first inference model to generate an aggregated demand prediction (not shown). Supply data from market data repository 200 may be used by a second inference model to generate an aggregated supply prediction (not shown). Refer to FIG. 2C for additional details regarding aggregated prediction generation.

The aggregated supply prediction and the aggregated demand prediction may be analyzed, and the output of the analysis may be compared to acceptability criteria. Recommendation 204 may then be generated based on the comparison to the acceptability criteria. Recommendation 204 may include a recommendation to add an options clause to a contract with a supplier to reduce a likelihood of product supply not meeting product demand and a recommended quantity of products to add to the options clause. Refer to FIG. 2D for additional details regarding recommendation generation using the aggregated predictions.

Recommendation 204 may then be used to perform negotiation process 206. During negotiation process 206, recommendation 204 may be used to generate a set of options offers. The set of options offers may include one or more options offers for each supplier. The set of options offers may then be provided to the suppliers.

In response to the set of options offers, a set of counteroffers may be obtained. Using the set of counteroffers and acceptability criteria, it may be determined whether the set of counteroffers is acceptable. If the set of counteroffers is not acceptable, the set of options offers may be iteratively modified until an acceptable set of counteroffers is obtained. Refer to FIG. 2B for additional details regarding negotiation process 206.

Once an acceptable set of counteroffers is obtained, negotiated contracts 208 may be generated. Negotiated contracts 208 may include a negotiated contract for each supplier. Each contract of negotiated contracts 208 may include an options clause indicating the quantity of products and price to be paid for the products indicated by a counteroffer of the set of counteroffers.

Thus, by implementing the data flow shown in FIG. 2A, a system in accordance with embodiments disclosed herein may increase the likelihood of generating negotiated contracts with suppliers for a product that include options clauses which optimize the quantity of products to be obtained from the suppliers and the price to be paid for the products.

Turning to FIG. 2B, a second data flow diagram in accordance with an embodiment is shown. The second data flow diagram may illustrate data used in and data processing performed in using a recommendation to generate negotiated contracts. FIG. 2B may be an expansion of negotiation process 206 shown in FIG. 2A.

To generate the negotiated contracts, recommendation 204 may be used to perform options offers generation process 210. Options offers generation process 210 may include generating a set of options offers, (e.g., options offers 212), wherein each options offer corresponds to a contract with a supplier (e.g., of suppliers 104). For example, an options offer of options offers 212 may indicate a first quantity of products to be provided by the supplier (e.g., supplier 104A) when the options clause is exercised and a first price to be paid for the products. Options offers generation process 210 may be performed by a neural network (e.g., an inference model) trained using training data to optimize each options offer as part of the set of options offers. Options offers 212 may be generated using the neural network so that a total quantity of products made available to purchase by the set of options offers is a sufficient quantity of the products to meet a need of a company.

For example, a company that produces computers which require a hard drive may have a contract with each of three suppliers (e.g., supplier A, supplier B, and supplier C) to purchase hard drives. The company may obtain a recommendation indicating that demand for hard drives may exceed supply of hard drives by 100 hard drives for a given confidence interval. The recommendation may be based on an uncertainty in the difference between the aggregated supply prediction and the aggregated demand prediction for hard drives equal to 100 hard drives. It may be recommended that the company adds a total of 100 hard drives to an options clause of at least one contract to hedge against a maximum quantity indicated by the uncertainty (e.g., add a quantity of hard drives to the contracts to 100% meet the uncertainty indicated by the initial recommendation) (refer to FIGS. 2C-2D for details regarding recommendation generation). The company may use a neural network to generate a set of three options offers, one options offer for each of the suppliers, which may optimize the cost per hard drive across the three suppliers. The options offers may include: 50 hard drives for $1 each from supplier A, 30 hard drives for $2 each from supplier B, and 20 hard drives for $3 each from supplier C for a total cost of $170 for 100 hard drives.

Options offers 212 may then be provided to the suppliers during supplier counteroffers collection process 214. During supplier counteroffers collection process 214, the suppliers may receive the options offers and may generate a response to the options offers (e.g., supplier counteroffers 216). Supplier counteroffers 216 may include a set of counteroffers including a counteroffer from each of the suppliers. For example, a counteroffer of supplier counteroffers 216 may indicate a second quantity of the products to be provided by the supplier when the options clause is exercised and a second price to be paid for the products.

Continuing with the above example, the company may obtain a set of counteroffers, one counteroffer from each of the three suppliers of hard drives in response to the set of options offers. The counteroffers may include: 25 hard drives for $1 each and 25 hard drives for $3 each from supplier A, 30 hard drives for $2 each from supplier B, and 20 hard drives for $5 each from supplier C for a total cost of $260 for 100 hard drives.

Supplier counteroffers 216 may be compared to acceptability criteria 218 during acceptability criteria comparison process 220. During acceptability criteria comparison process 220, a determination may be made regarding whether the counteroffers are acceptable. To make the determination, each counteroffer may be combined in order to compare the set of counteroffers to the acceptability criteria. The acceptability criteria may include a ratio of a cost for hedging against the uncertainty in the aggregated supply prediction and the aggregated demand prediction to a cost for insufficient product supply.

Continuing with the above example, the company may combine the counteroffers from each of the three suppliers to compare the set of counteroffers to the acceptability criteria. When combined, the set of counteroffers may provide for 100 hard drives for a total cost of $260. The company may compare the set of counteroffers to acceptability criteria, which may indicate that the cost for hedging against the uncertainty (e.g., $260 to hedge against the uncertainty 100%) is too high. To lower the cost for hedging against the uncertainty, the company may decide to decrease the percent of the uncertainty to be hedged against (e.g., decrease from 100% to 90%).

However, by lowering the cost for hedging against the uncertainty, the company may increase the risk of incurring costs due to insufficient product supply. For example, if the company lacks a hard drive, it may not be able to produce and sell a computer. If the profit generated from the sale of one computer is $1000, then the lack of a hard drive may cost the company $1000.

If it is determined during acceptability criteria comparison process 220 that supplier counteroffers 216 is acceptable, then the acceptable offers may be used to perform contract updating process 222. During contract updating process 222, an options clause may be added to a contract to include the quantity of products and price to be paid for the products indicated in the acceptable supplier counteroffer. As a result of contract updating process 222, negotiated contract 208 may be generated, including the updated contract and options clause.

If it is determined during acceptability criteria comparison process 220 that supplier counteroffers 216 is not acceptable, supplier counteroffers 216 may be used as the basis for generating an updated recommendation. The updated recommendation may then be used in options offers generation process 210 to generate a revised set of options offers.

Continuing with the above example, the acceptability criteria may indicate that the cost to hedge against the uncertainty 100% ($260 for 100 hard drives) is too high. An updated recommendation may be generated to decrease the percent of the uncertainty to hedge against to 90%, considering the ratio of the cost to hedge against the uncertainty to the cost of insufficient supply of hard drives ($1000 per hard drive).

Using the updated recommendation, options offers generation process 210 may be repeated to optimize costs for 90 hard drives (e.g., the quantity of hard drives needed to hedge against 90% of the uncertainty) across the three suppliers. The updated options offers may include: 25 hard drives for $1 each and 25 hard drives for $3 each from supplier A, 30 hard drives for $2 each from supplier B, and 10 hard drives for $5 each from supplier C for a total cost of $210 for 90 hard drives.

Supplier counteroffers collection process 214 may be performed using the updated options offers to collect updated supplier counteroffers. The updated supplier counteroffers may be compared to acceptability criteria 218 to determine if they are acceptable. If the updated supplier counteroffers are acceptable, they may be used to perform contract updating process 222. If the updated supplier counteroffers are not acceptable, the process may continue to iteratively modify the updated options offers until supplier counteroffers based on the modified updated options offers are acceptable.

Thus, by implementing the data flow shown in FIG. 2B, a system in accordance with embodiments disclosed herein may increase the likelihood of generating contracts with suppliers for a product which optimize the ratio between the cost to hedge against the uncertainty in the predicted difference between the supply of a product and the demand for a product and the cost of insufficient product supply. To optimize the ratio, the contracts with all suppliers of a product are considered, allowing for a global optimization in quantity and price of products to be performed.

Turning to FIG. 2C, a third data flow diagram in accordance with an embodiment is shown. The third data flow diagram may illustrate data used in and data processing performed in generating an aggregated supply prediction and/or an aggregated demand prediction to be used to generate a contract recommendation. FIG. 2C may be an expansion of recommendation generation process 202 shown in FIG. 2A.

To generate an aggregated supply prediction and/or an aggregated demand prediction, prediction generation process 230 may be performed. To perform prediction generation process 230, relevant data (e.g., demand data, supply data) may be obtained from market data repository 200 to generate predictions.

To generate the predictions, prediction generation process 230 may use an inference model. The inference model may use the relevant data as input to generate a set of predictions (e.g., prediction 232A-232N).

For example, a first inference model may be used to generate a set of demand predictions. The first inference model may be a neural network trained using first training data to predict product demand. To generate the set of demand predictions, the first inference model may ingest demand data from market data repository 200 regarding the demand for a product. The demand data may include: (i) historical data regarding demand for a product, (ii) historical data regarding consumer spending, (iii) data regarding the consumer and/or (iv) other data.

The first inference model may generate a set of demand predictions as output from the inference model, the set of demand predictions including a list that specifies internal consumers and sub-demand for each of the internal consumers. Internal consumers may include business divisions within the company which consume the product sold by the supplier (e.g., hard drives, monitors).

For example, a company may purchase hard drives from a supplier and may distribute the purchased hard drives to any number of internal consumers to use as a component in the products sold by the company. The internal consumers may include all of the business divisions within the company that produce products which consume a hard drive (e.g., a first business division responsible for building laptop computers, a second business division responsible for building desktop computers).

A first internal consumer may be associated with a first sub-demand (e.g., a number of hard drives needed by the first business division) and a second internal consumer may be associated with a second sub-demand (e.g., a number of hard drives needed by the second business division). The set of demand predictions may, therefore, include a list specifying sub-demand for each of the internal consumers.

For example, the company may use a first inference model to generate a set of demand predictions including: (i) a prediction regarding the demand for hard drives by the first business division (e.g., prediction 232A) and (ii) a prediction regarding the demand for hard drives by the second business division (e.g., prediction 232B).

Prediction generation process 230 may also include a second inference model to generate a set of supply predictions. The second inference model may be a neural network trained using second training data to predict product supply. To generate the set of supply predictions, the inference model may ingest supply data from market data repository 200 regarding the supply of a product. The supply data may include: (i) historical data regarding market availability of the product, (ii) historical data regarding supply of the product from a supplier, (iii) historical data regarding a likelihood of contract fulfillment by a supplier, (iv) data regarding the supplier, and/or (v) other data. The second inference model may generate a set of supply predictions as output from the inference model, the set of supply predictions including a list that specifies suppliers and sub-supply for each of the suppliers (e.g., the supply of the product from each of the suppliers).

Continuing with the above example, the company that sells computers may obtain hard drives from any number of suppliers. The company may use a second inference model to generate a set of supply predictions including: (i) a prediction regarding the supply of hard drives from a first supplier (prediction 232C) and (ii) a prediction regarding the supply of hard drives from a second supplier (prediction 232D).

After prediction generation process 230, prediction aggregation process 234 may be performed. To perform prediction aggregation process 234, generated predictions (e.g., the set of demand predictions, the set of supply predictions) may be combined to obtain an aggregated prediction 236 (e.g., an aggregated demand prediction, an aggregated supply prediction).

The aggregated demand prediction may be a sum of the sub-demand for each of the internal consumers, representing the total demand for the product obtained from the supplier. For example, the aggregated demand prediction for hard drives may include a sum of the sub-demand for hard drives (e.g., a total demand for hard drives across all internal consumers).

Continuing with the above example, the company may be reviewing a contract for hard drives to determine whether the current contract will provide a sufficient quantity of hard drives to allow the company to meet demand for computers containing hard drives (e.g., laptop computers and desktop computers). To assess demand for hard drives, the predictions regarding the demand for hard drives may be combined (e.g., prediction 232A and prediction 232B) to obtain an aggregated demand prediction for hard drives.

Similarly, to assess supply of hard drives, the predictions regarding the supply of hard drives from the suppliers may be combined (e.g., prediction 232C and prediction 232D) to obtain an aggregated supply prediction for hard drives. The aggregated supply prediction may be a sum of the sub-supply for each of the suppliers. For example, the aggregated supply prediction for hard drives may be a sum of the sub-supply for hard drives (e.g., supply of hard drives from each of the suppliers).

Thus, via the processes illustrated in FIG. 2C, a system in accordance with an embodiment may generate an aggregated supply and/or an aggregated demand prediction. By combining individual predictions to obtain an aggregated prediction, the total supply and total demand for a product may be compared, which may increase the likelihood of accurately calculating the difference between the supply and the demand of a product used to make contract recommendations.

Turning to FIG. 2D, a fourth data flow diagram in accordance with an embodiment is shown. The fourth data flow diagram may illustrate data used in and data processing performed in comparing the aggregated supply prediction to the aggregated demand prediction to generate a contract recommendation. FIG. 2D may be an expansion of recommendation generation process 202 shown in FIG. 2A.

To compare aggregated supply prediction 240 to aggregated demand prediction 242, prediction comparison process 244 may be performed. During prediction comparison process 244, aggregated supply prediction 240 and aggregated demand prediction 242 may be analyzed to generate a difference (e.g., prediction difference 246). Prediction difference 246 may indicate a quantity of products needed for product supply to meet product demand over a duration of time, as well as a level of uncertainty in the quantity. The level of uncertainty in the quantity may be generated using a quantile regression analysis process of the aggregated supply prediction and the aggregated demand prediction. The level of uncertainty in the quantity may be obtained via other methods without departing from embodiments disclosed herein.

For example, if the aggregated supply prediction for a product is less than the aggregated demand prediction for a product, the prediction difference may indicate the quantity of products needed for the product supply to meet product demand. The prediction difference may also indicate a level of uncertainty in the quantity. For example, when calculating the quantity of products needed for product supply to meet product demand, there may be an error associated with the quantity.

After the generation of prediction difference 246, acceptability criteria comparison process 250 may be performed. To perform acceptability criteria comparison process 250, prediction difference 246 may be compared to acceptability criteria 218. Acceptability criteria 218 may indicate an uncertainty in the difference between supply and demand that is acceptable for the company to continue with the existing contract based on a ratio of the cost for hedging against the uncertainty to the cost for insufficient product supply. Refer to FIG. 2B for additional details regarding acceptability criteria 218.

For example, acceptability criteria 218 may be used to obtain a value of the uncertainty in the difference at or below which the addition of an options clause to a contract for a product is not recommended, the options clause indicating a quantity of products to be provided by the supplier when the options clause is exercised. If prediction difference 246 indicates a value above acceptability criteria 218, the addition of an options clause to the contract for a product may be recommended.

By performing acceptability criteria comparison process 250, recommendation 204 may be generated. If recommendation 204 recommends the addition of an options clause to the contract, it may indicate the quantity of products needed to hedge against the uncertainty to reduce the likelihood of the quantity of products provided by the supplier in the contract not meeting the product demand.

For example, if the addition of an options clause is recommended, it may recommend the addition of the quantity of products needed to equal the maximum value of the uncertainty in the difference between the aggregated demand prediction and the aggregated supply prediction. The uncertainty value may represent the probability that the quantity of products provided by the supplier in the contract is not sufficient to meet product demand. An increase in the level of uncertainty in the quantity of products needed for the supply of the product to meet the demand for the product may indicate an increase in a probability that the quantity of the products provided by the supplier according to the contract will not be sufficient to allow product supply to meet product demand.

For example, the uncertainty value may represent the error in the calculation of the quantity of products needed for product supply to meet product demand. In order to increase a likelihood that product supply will meet product demand, the options clause may include the quantity of products needed to meet the maximum quantity of products indicated by the error.

For example, the quantity of hard drives needed by the company to meet demand for computers containing hard drives may be calculated to be 100±10 hard drives (e.g., the quantity of hard drives needed for hard drive supply to meet hard drive demand plus or minus the error). To reduce the risk that the company has an insufficient quantity of hard drives, the company may include 10 hard drives in the options clause (e.g., the quantity of hard drives needed to equal the maximum quantity indicated by the error).

While described above with respect to an options clause including additional product to be provided by the supplier when the options clause is exercised, it will be appreciated that the options clause may include a reduction in the quantity of products to be provided by the supplier without departing from embodiments disclosed herein. Such an options clause may allow for an uncertainty indicating lower than expected demand to be hedged against.

Thus, via the processes illustrated in FIG. 2D, a system in accordance with an embodiment may use an aggregated supply prediction and an aggregated demand prediction to generate a contract recommendation. By comparing the aggregated supply prediction to the aggregated demand prediction to obtain a difference and uncertainty in the difference, it may increase a likelihood that an accurate and quantitative recommendation be made regarding the addition of an options clause to a contract. The use of the uncertainty value to determine the quantity of products to add to the options clause may further reduce the likelihood that the supply of the product does not meet demand.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2D may perform various methods to manage contracts. FIG. 3 illustrates a method that may be performed by the components of the system of FIGS. 1-2D. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing contracts in accordance with an embodiment is shown. The method may be performed, for example, by any of the components of the system of FIG. 1, and/or any other entity without departing from embodiments disclosed herein.

At operation 300 a recommendation may be obtained. The recommendation may indicate that an options clause is to be added to a contract.

Obtaining the recommendation may include (i) obtaining, using a set of demand predictions generated by a first inference model, an aggregated demand prediction, the aggregated demand prediction being intended to predict demand for the products over a duration of time, (ii) comparing the aggregated demand prediction to an aggregated supply prediction, the aggregated supply prediction being based on a set of supply predictions generated by a second inference model and being intended to predict supply of the products over the duration of time to obtain a difference, (iii) making a determination, using the difference and the acceptability criteria, regarding whether the difference is acceptable, (iv) in a first instance of the determination in which the difference is not acceptable: generating the recommendation to add the options clause to the contract with a supplier, the recommendation indicating a quantity of the products to be provided by the supplier when the options clause is exercised, and/or (v) other methods.

Obtaining the aggregating demand prediction may include (i) obtaining demand data (e.g., reading the demand data from storage, receiving the demand data from another device), (ii) obtaining a set of demand predictions using a first inference model (e.g., generating the set of demand predictions using a neural network using the demand data as ingest for the neural network, receiving the set of demand predictions from another device), (iii) aggregating the set of demand predictions to obtain the aggregated demand prediction (e.g., combining the set of demand predictions to account for the total product demand, providing the set of demand predictions to another entity responsible for aggregating the set of demand predictions), and/or (iv) other methods.

Comparing the aggregated demand prediction to the aggregated supply prediction may include (i) obtaining the aggregated supply prediction, (ii) subtracting the quantity of products indicated by the aggregated supply prediction from the quantity of products indicated by the aggregated demand prediction to obtain a difference indicating the quantity of products needed for supply to meet demand, and/or (iii) other methods.

Obtaining the aggregated supply prediction may include (i) obtaining supply data (e.g., reading the supply data from storage, receiving the supply data from another device), (ii) obtaining a set of supply predictions using a second inference model (e.g., generating the set of supply predictions using a neural network using the supply data as ingest for the neural network, receiving the set of supply predictions from another device), (iii) aggregating the set of supply predictions to obtain the aggregated supply prediction (e.g., combining the set of supply predictions to account for the total product supply, providing the set of supply predictions to another entity responsible for aggregating the set of supply predictions), and/or (iv) other methods.

Obtaining a difference may include obtaining an uncertainty in the difference. Obtaining the uncertainty in the difference may include: (i) generating the uncertainty based on an uncertainty in the aggregated demand prediction and an uncertainty in the aggregated supply prediction, (ii) generating the uncertainty using quantile regression analysis of the aggregated demand prediction and the aggregated supply prediction, (iii) providing the aggregated supply prediction and the aggregated demand prediction to another entity responsible for generating the uncertainty in the difference, and/or (iv) other methods.

Making a determination regarding whether the difference is acceptable may include obtaining acceptability criteria and analyzing the difference to ascertain whether it meets the acceptability criteria. Analyzing the difference to ascertain whether it meets the acceptability criteria may include: (i) comparing a quantity of the difference to a quantity indicated by the acceptability criteria, (ii) providing the difference and the acceptability criteria to another device responsible for comparing the difference to the acceptability criteria and receiving a report as a response, the report indicating whether the difference is acceptable, and/or (iii) other methods.

Generating the recommendation to add the options clause to the contract with a supplier may include (i) using the acceptability criteria to determine the quantity of products needed to hedge against a level of the uncertainty in the difference between the aggregated supply prediction of the products and the aggregated demand prediction for the products, (ii) providing the acceptability criteria and the difference to another device responsible for generating the recommendation and receiving the recommendation as a response.

At operation 302, an options offer of a set of options offers may be obtained using the recommendation, the options offer indicating a first quantity of the products to be provided by a supplier when the options clause is exercised and a first price to be paid for the products.

Obtaining the options offer of the set of options offers may include (i) obtaining a neural network trained using training data to globally optimize the options offer as part of the set of options offers (e.g., generating the trained neural network using the training data, receiving the trained neural network from another device), (ii) generating the options offer using the neural network so that a total quantity of products covered in the set of options offers is a sufficient quantity of the products to meet a need of a company (e.g., making predictions using the neural network regarding the quantity of products to include in the options offer, combining the quantity of products across options offers to obtain a total quantity of products) and/or (iii) other methods.

At operation 304, a counteroffer of a set of counteroffers may be obtained. The counteroffer may be obtained from the supplier and may indicate a second quantity of products to be provided by the supplier when the options clause is exercised and a second price to be paid for the products.

Obtaining the counteroffer of a set of counteroffers may include (i) reading the counteroffer from storage, (ii) receiving the counteroffer from another device, and/or (iii) other methods.

At operation 306, it may be determined whether the counteroffer is acceptable based on acceptability criteria. Making the determination may include combining each counteroffer in the set of counteroffers to compare the set of counteroffers to the acceptability criteria.

Combining each counteroffer in the set of counteroffers may include (i) combining the quantity of products indicated by each counteroffer to obtain a total quantity of products, (ii) combining the cost of each product indicated by each counteroffer to obtain a total cost, (iii) providing the counteroffers to another device responsible for combining them, and/or (iv) other methods.

Making the determination may also include obtaining the acceptability criteria and analyzing the counteroffer to ascertain whether it meets the acceptability criteria. Obtaining the acceptability criteria may include (i) reading the acceptability criteria from storage, (ii) generating the acceptability criteria based on the needs of the company, (iii) receiving the acceptability criteria from another device, and/or (iv) other methods.

Analyzing the counteroffer to ascertain whether it meets the acceptability criteria may include (i) comparing a quantity of the counteroffer to a quantity indicated by the criteria, (ii) providing the counteroffer and the acceptability criteria to another device responsible for comparing the counteroffer to the acceptability criteria and receiving a report as a response, the report indicating whether the counteroffer is acceptable, and/or (iii) other methods.

If it is determined that the counteroffer is acceptable based on the acceptability criteria (e.g., the determination is “Yes” at operation 306), then the method may proceed to operation 308.

At operation 308, the contract may be updated to include the options clause, the options clause indicating the second quantity of products to be provided by the suppliers when the options clause is exercised and the second price to be paid for the products. Updating the contract to include the options clause may include (i) generating the options clause based on the second quantity of products and second price to be paid for the products, (ii) providing the second quantity of products and second price to be paid for the products to another device responsible for updating the contract with the options clause, and/or (iii) other methods. The method may end following operation 308.

Returning to operation 306, if it is determined that the counteroffer is not acceptable based on the acceptability criteria (e.g., the determination is “No” at operation 306), then the method may proceed to operation 310.

At operation 310, the options offer may be modified until a counteroffer based on the modified options offer is acceptable. Modifying the options offer until a counteroffer based on the modified options offer is acceptable may include (i) obtaining an updated options offer (e.g., generating an updated options offer based on the counteroffer and acceptability criteria, receiving an updated options offer from another device), (ii) obtaining an updated counteroffer from the supplier (e.g., reading the updated counteroffer from storage, receiving the updated counteroffer from the supplier), (iii) making a second determination using the acceptability criteria regarding whether the updated counteroffer is acceptable (e.g., obtaining the acceptability criteria, analyzing the updated counteroffer to ascertain whether it meets the acceptability criteria), (iv) in a first instance of the second determination in which the updated counteroffer is not acceptable: continuing to iteratively modify the updated options offer until a counteroffer based on the modified updated options offer is acceptable (e.g., generating a modified updated options offer based on the updated counteroffer, receiving a modified updated options offer from another device) and/or (v) other methods.

The method may end following operation 310.

Thus, using the methods illustrated in FIG. 3, embodiments disclosed herein may provide systems and methods usable to manage contracts to globally optimize the quantity of products and the price to be paid per product included in the options clause of contracts across multiple suppliers.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing contracts, the method comprising:
obtaining a recommendation, the recommendation indicating that an options clause is to be added to a contract of the contracts;
obtaining, using the recommendation, an options offer of a set of options offers, the options offer indicating a first quantity of products to be provided by a supplier of the suppliers when the options clause is exercised and a first price to be paid for the products;
obtaining a counteroffer of a set of counteroffers, the counteroffer being obtained from the supplier and indicating a second quantity of the products to be provided by the supplier when the options clause is exercised and a second price to be paid for the products;
making a determination, using the counteroffer and acceptability criteria, regarding whether the counteroffer is acceptable; and
in a first instance of the determination in which the counteroffer is acceptable based on the acceptability criteria:
updating the contract to include the options clause, the options clause indicating the second quantity of products to be provided by the suppliers when the options clause is exercised and the second price to be paid for the products.

2. The method of claim 1, further comprising:
in a second instance of the determination in which the counteroffer is not acceptable based on the acceptability criteria:
obtaining an updated options offer;
obtaining an updated counteroffer from the supplier;
making a second determination, using the acceptability criteria regarding whether the updated counteroffer is acceptable; and
in a first instance of the second determination in which the updated counteroffer is not acceptable:
continuing to iteratively modify the updated options offer until a counteroffer based on the modified updated options offer is acceptable.

3. The method of claim 1, wherein obtaining the recommendation comprises:
obtaining, using a set of demand predictions generated by a first inference model, an aggregated demand prediction, the aggregated demand prediction being intended to predict demand for the products over a duration of time;
comparing the aggregated demand prediction to an aggregated supply prediction, the aggregated supply prediction being based on a set of supply predictions generated by a second inference model and being intended to predict supply of the products over the duration of time to obtain a difference;
making a determination, using the difference and the acceptability criteria, regarding whether the difference is acceptable; and
in a first instance of the determination in which the difference is not acceptable:
generating the recommendation to add the options clause to the contract with a supplier, the recommendation indicating a quantity of the products to be provided by the supplier when the options clause is exercised.

4. The method of claim 3, wherein obtaining the aggregated demand prediction comprises:
obtaining demand data;
obtaining, using the first inference model and the demand data, the set of demand predictions; and
aggregating the set of demand predictions to obtain the aggregated demand prediction.

5. The method of claim 4, wherein comparing the aggregated demand prediction to the aggregated supply prediction comprises:
obtaining supply data;
obtaining, using the second inference model and the supply data, the set of supply predictions; and
aggregating the set of supply predictions to obtain the aggregated supply prediction.

6. The method of claim 5, wherein the difference comprises:
a quantity of products needed for product supply to meet product demand over the duration of time; and
a level of uncertainty in the quantity of products needed for the product supply to meet the product demand over the duration of time.

7. The method of claim 6, wherein the level of uncertainty in the quantity of products needed for the product supply to meet the product demand over the duration of time is obtained using quantile regression.

8. The method of claim 6, wherein the options clause comprises:
a quantity of products, the quantity comprising:
the quantity of products needed to hedge against the uncertainty to reduce a likelihood of the quantity of products not meeting the product demand.

9. The method of claim 1, wherein the set of options offers comprises one or more options offers for each supplier of the suppliers.

10. The method of claim 9, wherein obtaining the options offer of the set of options offers comprises:
obtaining a neural network trained using training data to globally optimize the options offer as part of the set of options offers; and
generating the options offer using the neural network so that a total quantity of products covered the set of options offers is a sufficient quantity of the products to meet a need of a company.

11. The method of claim 1, wherein making the determination comprises combining each counteroffer in the set of counteroffers to compare the set of counteroffers to the acceptability criteria.

12. The method of claim 1, wherein the acceptability criteria comprises a ratio of a cost for hedging against uncertainty in an aggregated supply prediction and an aggregated demand prediction to a cost for insufficient product supply.

13. A non-transitory machine-readable medium having instructions stored therein, which when executed by a processor, cause the processor to perform operations for managing contracts, the operations comprising:
obtaining a recommendation, the recommendation indicating that an options clause is to be added to a contract of the contracts;
obtaining, using the recommendation, an options offer of a set of options offers, the options offer indicating a first quantity of products to be provided by a supplier of the suppliers when the options clause is exercised and a first price to be paid for the products;
obtaining a counteroffer of a set of counteroffers, the counteroffer being obtained from the supplier and indicating a second quantity of the products to be provided by the supplier when the options clause is exercised and a second price to be paid for the products;
making a determination, using the counteroffer and acceptability criteria, regarding whether the counteroffer is acceptable; and
in a first instance of the determination in which the counteroffer is acceptable based on the acceptability criteria:
updating the contract to include the options clause, the options clause indicating the second quantity of products to be provided by the suppliers when the options clause is exercised and the second price to be paid for the products.

14. The non-transitory machine-readable medium of claim 13, further comprising:
in a second instance of the determination in which the counteroffer is not acceptable based on the acceptability criteria:
obtaining an updated options offer;
obtaining an updated counteroffer from the supplier;
making a second determination, using the acceptability criteria regarding whether the updated counteroffer is acceptable; and
in a first instance of the second determination in which the updated counteroffer is not acceptable:
continuing to iteratively modify the updated options offer until a counteroffer based on the modified updated options offer is acceptable.

15. The non-transitory machine-readable medium of claim 13, wherein obtaining the recommendation comprises:
obtaining, using a set of demand predictions generated by a first inference model, an aggregated demand prediction, the aggregated demand prediction being intended to predict demand for the products over a duration of time;
comparing the aggregated demand prediction to an aggregated supply prediction, the aggregated supply prediction being based on a set of supply predictions generated by a second inference model and being intended to predict supply of the products over the duration of time to obtain a difference;
making a determination, using the difference and the acceptability criteria, regarding whether the difference is acceptable; and
in a first instance of the determination in which the difference is not acceptable:
generating the recommendation to add the options clause to the contract with a supplier, the recommendation indicating a quantity of the products to be provided by the supplier when the options clause is exercised.

16. The non-transitory machine-readable medium of claim 15, wherein obtaining the aggregated demand prediction comprises:
obtaining demand data;
obtaining, using the first inference model and the demand data, the set of demand predictions; and
aggregating the set of demand predictions to obtain the aggregated demand prediction.

17. A data processing system, comprising:
a processor; and
a memory coupled to the processor to store instructions, which when executed by the processor, cause the processor to perform operations for managing contracts, the operations comprising:
obtaining a recommendation, the recommendation indicating that an options clause is to be added to a contract of the contracts;
obtaining, using the recommendation, an options offer of a set of options offers, the options offer indicating a first quantity of products to be provided by a supplier of the suppliers when the options clause is exercised and a first price to be paid for the products;
obtaining a counteroffer of a set of counteroffers, the counteroffer being obtained from the supplier and indicating a second quantity of the products to be provided by the supplier when the options clause is exercised and a second price to be paid for the products;
making a determination, using the counteroffer and acceptability criteria, regarding whether the counteroffer is acceptable; and
in a first instance of the determination in which the counteroffer is acceptable based on the acceptability criteria:
updating the contract to include the options clause, the options clause indicating the second quantity of products to be provided by the suppliers when the options clause is exercised and the second price to be paid for the products.

18. The data processing system of claim 17, further comprising:
in a second instance of the determination in which the counteroffer is not acceptable based on the acceptability criteria:
obtaining an updated options offer;
obtaining an updated counteroffer from the supplier;
making a second determination, using the acceptability criteria regarding whether the updated counteroffer is acceptable; and
in a first instance of the second determination in which the updated counteroffer is not acceptable:
continuing to iteratively modify the updated options offer until a counteroffer based on the modified updated options offer is acceptable.

19. The data processing system of claim 17, wherein obtaining the recommendation comprises:
obtaining, using a set of demand predictions generated by a first inference model, an aggregated demand prediction, the aggregated demand prediction being intended to predict demand for the products over a duration of time;
comparing the aggregated demand prediction to an aggregated supply prediction, the aggregated supply prediction being based on a set of supply predictions generated by a second inference model and being intended to predict supply of the products over the duration of time to obtain a difference;
making a determination, using the difference and the acceptability criteria, regarding whether the difference is acceptable; and
in a first instance of the determination in which the difference is not acceptable:
generating the recommendation to add the options clause to the contract with a supplier, the recommendation indicating a quantity of the products to be provided by the supplier when the options clause is exercised.

20. The data processing system of claim 19, wherein obtaining the aggregated demand prediction comprises:
obtaining demand data;
obtaining, using the first inference model and the demand data, the set of demand predictions; and
aggregating the set of demand predictions to obtain the aggregated demand prediction.
